(19) United States
(12) Patent Application Publication
(10) Pub. No.: US 2013/0209878 A1
(43) Pub. Date: Aug. 15, 2013

(54) NONAQUEOUS SECONDARY CELL AND METHOD OF MANUFACTURING THE SAME

(71) Applicants: Kentaro Nakahara, Tokyo (JP); Osamu Yamashita, Tokyo (JP); Takanori Nishi, Tokyo (JP); Haruyuki Yoshigahara, Tokyo (JP); Yoichi Shimizu, Tokyo (JP)

(72) Inventors: Kentaro Nakahara, Tokyo (JP); Osamu Yamashita, Tokyo (JP); Takanori Nishi, Tokyo (JP); Haruyuki Yoshigahara, Tokyo (JP); Yoichi Shimizu, Tokyo (JP)

(73) Assignee: NEC CORPORATION, Tokyo (JP)

(21) Appl. No.: 13/820,360

(22) PCT Filed: Aug. 12, 2011
(86) PCT No.: PCT/JP2011/068722

§ 371 Date: Mar. 26, 2013

(30) Foreign Application Priority Data
Sep. 3, 2010 (JP) 2010-197284

(51) Int. Cl. H01M 10/0525; H01M 10/04; H01M 10/058

(52) U.S. Cl. CPC H01M 10/0525; H01M 10/058; H01M 10/0436
USPC 429/211; 29/623.1

(57) ABSTRACT

A thin nonaqueous secondary cell has high stability where a positive charge collector and a negative charge collector also serve as outer covering members. A sealing layer concurrently achieves high adhesiveness with both electrode charge collectors, high reliability preventing of short circuits, and satisfactory gas barrier properties. The nonaqueous secondary cell includes a positive charge collector containing aluminum as a primary component, a positive electrode layer formed on the positive charge collector, a negative charge collector containing copper as a primary component, a negative electrode layer formed on the negative charge collector so the negative electrode layer opposes the positive electrode layer, and a separator including an electrolyte between positive and negative electrode layers. Inner surfaces of a peripheries of positive and negative charge collectors are connected while a sealing material including a multilayered structure is interposed between the inner surfaces of the peripheries of the two charge collectors.

### BACKGROUND OF THE INVENTION

The present invention relates to a nonaqueous secondary cell and a method of manufacturing the same.

A lithium-ion secondary cell, which is a nonaqueous secondary cell having a high energy density, has been used as a power source for various portable devices such as cellular phones or notebook computers. The shape of a lithium-ion secondary cell is mostly cylindrical or rectangular parallelepiped. In most cases, a lithium-ion secondary cell is formed by inserting a rolled electrode layered body into a metal can. Some types of portable devices require a cell having a reduced thickness. However, since a metal can is produced by deep drawing, it is difficult to reduce the thickness of a metal can to 3 mm or less.

Various types of IC cards and non-contact IC cards have widely been used in recent years. Most of non-contact IC cards comprise a system that generates power with an electromagnetic induction type coil, so that electric circuits are operated only in actual use. In order to provide those IC cards with a display function or a sensing function for remarkably improving the security and convenience of the IC cards, it is preferable to use a secondary cell as an energy source within the IC cards. The size of IC cards is standardized into 85 mm×48 mm×0.76 mm. Therefore, a built-in secondary cell is required to have a thickness of 0.76 mm or less. Furthermore, the thickness of secondary cells in various types of card devices that do not conform to the standard should preferably be 2.5 mm or less.

Aluminum film laminates are often used as outer covering members for thin nonaqueous secondary cells having a thickness of 2.5 mm or less. An aluminum film laminate primarily includes a thermoplastic resin layer, an aluminum foil layer, and an insulator layer. An aluminum film laminate is characterized in that it can readily be formed and processed while it has satisfactory gas barrier properties. However, in a case of a thin nonaqueous secondary cell, a ratio of the thickness of an outer covering member to the overall thickness of the cell is so high that a technique of reducing the thickness of an outer covering member as much as possible is required to enhance the energy density.

JP-A 2007-073402 (Patent Literature 1) discloses an aluminum film laminate including a seven-layer structure including the innermost layer, a first adhesive layer, a first surface treatment layer, an aluminum foil layer, a second surface treatment layer, a second adhesive layer, and the outermost layer. This aluminum film laminate exhibits excellent formability, gas barrier properties, heat-sealing properties, and electrolyte resistance.

JP-A 09-077960 (Patent Literature 2) proposes a thin cell that comprise a positive charge collector and a negative charge collector that also serve as outer covering members and thus needs no aluminum laminate. In this cell, peripheries of the positive charge collector and the negative charge collector are connected to each other with a sealing material of polyolefin or engineering plastic.

JP-A 2003-059486 (Patent Literature 3) also proposes a thin cell that comprises a positive charge collector and a negative charge collector also serving as an outer covering member and thus needs no aluminum laminate. This reference proposes that peripheries of the positive charge collector and the negative charge collector are connected to each other with an olefin-based hot-melt resin, a urethane-based reaction hot-melt resin, an ethylene-vinylalcohol-based hot-melt resin, a polyamide-based hot-melt resin, and the like, and that inorganic filler is filled in those hot-melt resins.

Furthermore, JP-A 2005-191288 (Patent Literature 4) discloses a structure of an electric double layer capacitor in which an electrolyte is sandwiched between a positive charge collector of aluminum and a negative charge collector of aluminum while gaps are filled with a multilayered structure including a deposition layer and a gas barrier layer. In other words, Patent Literature 4 discloses an electric double layer capacitor including a positive charge collector and a negative charge collector that are formed of the same aluminum.

### DISCLOSURE OF THE INVENTION

However, the inventions disclosed in the above references suffer from the following problems.

First, according to the invention disclosed in Patent Literature 1, the thickness of the aluminum foil layer should be at least 8 μm, preferably at least 30 μm in order for the aluminum film laminate to have satisfactory gas barrier properties. Accordingly, there is a problem that the overall thickness of the aluminum film laminate becomes at least 73 μm, preferably at least 100 μm.

Furthermore, the invention disclosed in Patent Literature 2 suffers from problems of adhesiveness of the sealing material with the charge collectors, short circuits produced between the electrodes, and transmission of gas.

Moreover, according to the invention disclosed in Patent Literature 3, it is difficult to concurrently achieve high adhesiveness with the charge collectors, high reliability for prevention of short circuits produced between the electrodes, and satisfactory gas barrier properties, as with Patent Literature 2.

Meanwhile, according to the invention disclosed in Patent Literature 4, the negative charge collector made of aluminum is alloyed with lithium included in the electrolyte, thereby significantly lowering the durability.

The present invention has been made for the above reasons. It is, therefore, an object of the present invention to provide a thin nonaqueous secondary cell having high stability where a positive charge collector and a negative charge collector also serve as outer covering members.

In order to achieve the aforementioned object, according to a first aspect of the present invention, a nonaqueous secondary cell is characterized by comprising a positive charge collector containing aluminum as a primary component, a positive electrode layer formed on the positive charge collector, a negative charge collector containing copper as a primary component, a negative electrode layer formed on the negative charge collector so that the negative electrode layer is opposed to the positive electrode layer, and a separator provided between the positive electrode layer and the negative electrode layer, the separator including an electrolyte, wherein an inner surface of a periphery of the positive charge collector and an inner surface of a periphery of the negative charge collector are connected to each other while a sealing material comprising a multilayered structure including at least a positive fusion layer, a gas barrier layer, and a negative fusion layer is interposed between the inner surfaces of the peripheries of the positive charge collector and the negative charge collector.

The term “primary component” refers to a component having the highest composition ratio.

According to a second aspect of the present invention, a method of manufacturing a nonaqueous secondary cell is characterized by forming a film-like sealing material comprising a multilayered structure including at least a positive fusion layer, a gas barrier layer, and a negative fusion layer into a framed shape in which a central portion thereof has been punched out, interposing the film-like sealing material between a positive charge collector containing aluminum as a primary component and a negative charge collector containing copper as a primary component, and then connecting the positive charge collector and the negative charge collector to each other by heat sealing.

### ADVANTAGEOUS EFFECTS OF THE INVENTION

According to the present invention, a thin nonaqueous secondary cell having high stability where a positive charge collector containing aluminum as a primary component and a negative charge collector containing copper as a primary component also serve as outer covering members can be provided by using a sealing layer that can concurrently achieve high adhesiveness with both electrode charge collectors, high reliability for prevention of short circuits, and satisfactory gas barrier properties.

### BRIEF DESCRIPTION OF DRAWINGS

FIG. 1 is a cross-sectional view of a nonaqueous secondary cell according to an embodiment of the present invention.

### DESCRIPTION OF REFERENCE NUMERALS

1 positive charge collector
2 positive electrode layer
3 separator
4 negative electrode layer
5 negative charge collector
6 positive fusion layer
7 gas barrier layer
8 negative fusion layer
9 insulation layer

### MODE(S) FOR CARRYING OUT THE INVENTION

### Structure

Next, an embodiment of the present invention will be described below with reference to the drawing.

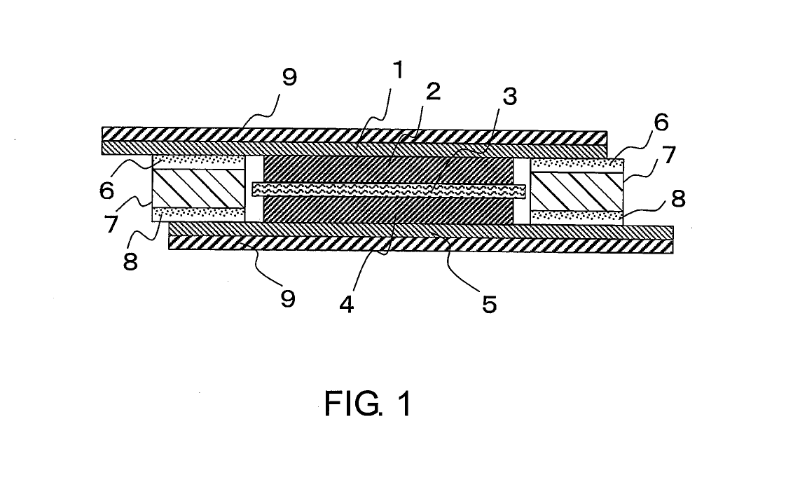

FIG. 1 shows a cross-sectional view of a nonaqueous secondary cell according to a first embodiment of the present invention. The illustrated nonaqueous secondary cell comprises a structure in which a positive electrode layer 2 formed on a positive charge collector 1 and a negative electrode layer 4 formed on a negative charge collector 5 are opposed to each other while a separator 3 including an electrolyte is interposed between the positive electrode layer 2 and the negative electrode layer 4. Inner surfaces of peripheries of the positive charge collector 1 and the negative charge collector 5 are connected to each other while a sealing material comprising a three-layer structure including a positive fusion layer 6, a gas barrier layer 7, and a negative fusion layer 8 is interposed between the inner surfaces of the peripheries of the positive charge collector 1 and the negative charge collector 5.

An insulation layer 9 is attached to each of outer surfaces of the positive charge collector 1 and the negative charge collector 5.

For example, a lithium manganate such as LiMn₂O₄, which is an oxide comprising a Spinel structure, may be used as an active material included in the positive electrode layer 2.

Nevertheless, an active material included in the positive electrode layer 2 is not necessarily limited to this example. For example, LiNi_{0.5}Mn_{1.5}O₄, which is also an oxide comprising a Spinel structure, LiFePO₄, LiMnPO₄, and Li₂CoPO₄F, each of which is an oxide comprising an olivine structure, LiCoO₂, LiNi_{1-x-y}CoₓAl_{y}O₂, and LiNi_{0.5-x}Mn_{0.5-x}Co₂₋ₓO₂, each of which is an oxide comprising a layered rock salt structure, a solid solution of such an oxide comprising a layered rock salt structure and Li₂MnO₃, sulfur, nitroxyl radical polymer, and the like may be used as an active material included in the positive electrode layer 2. Furthermore, a plurality of kinds of such positive active materials may be mixed and used. Particularly, nitroxyl radical polymer is a flexible positive active material, unlike other oxides. Therefore, nitroxyl radical polymer is a preferable positive active material for a flexible thin nonaqueous secondary cell incorporated in an IC card.

For example, the percentage content of the active material in the positive electrode is 90 wt %. Nevertheless, the percentage content of the active material may be adjusted into any desired value. If the percentage content of the active material to the whole weight of the positive electrode is 10 weight % or higher, a satisfactory capacity can be obtained. In order to obtain the largest possible capacity, the percentage content of the active material should preferably be 50 weight % or higher, more preferably 80 weight % or higher.

In order to provide the positive electrode layer 2 with conductivity, a conductivity provision agent is included in the positive electrode layer 2. For example, graphite powder or acetylene black having an average grain diameter of 6 μm may be used as a conductivity provision agent. Nevertheless, any conventional known conductivity provision agent may be used instead. Examples of conventional known conductivity provision agents include carbon black, furnace black, vapor deposition carbon fiber, carbon nanotube, carbon nanohorn, metal powder, conductive polymer, and the like.

In order to bind the aforementioned materials, a binding agent is included in the positive electrode layer 2. For example, polyvinylidene fluoride may be used as a binding agent. Nevertheless, any conventional known binding agent may be used instead. Examples of conventional known binding agents include polytetrafluoroethylene, vinylidene fluoride-hexafluoropropylene copolymer, styrene-butadiene copolymer rubber, polypropylene, polyethylene, polyacrylonitrile, acrylic resin, and the like.

As described later, the positive electrode layer 2 is produced by dispersing the aforementioned materials in a solvent to produce positive electrode ink, printing and applying the positive electrode ink, and heating and drying the positive electrode ink to remove the dispersion solvent. Conventional known dispersion solvents, such as N-methylpyrrolidone (NMP), water, and tetrahydrofuran, may be used as a dispersion solvent for the positive electrode ink.

Graphite such as mesocarbon microbeads (hereinafter MCMB) may be used as a negative active material included in the negative electrode layer 4. Nevertheless, a negative active material included in the negative electrode layer 4 is not necessarily limited to this example. For example, the negative active material may be replaced with a conventional known negative active material. Examples of conventional known negative active materials include carbon material such as activated carbon or hard carbon, lithium, lithium alloy, lithium-ion absorbing carbon, and various kinds of other metals or metal alloys.

In order to provide the negative electrode layer 4 with conductivity, a conductivity provision agent is included in the negative electrode layer 4. For example, a conductivity provision agent containing acetylene black as a primary component may be used. Nevertheless, any conventional known conductivity provision agent may be used instead. Examples of conventional known conductivity provision agents include carbon black, acetylene black, graphite, furnace black, vapor deposition carbon fiber, carbon nanotube, carbon nanohorn, metal powder, conductive polymer, and the like.

In order to bind the aforementioned materials, a binding agent is included in the negative electrode layer 4. For example, polyvinylidene fluoride may be used as a binding agent. Nevertheless, any conventional known binding agent may be used instead. Examples of conventional known binding agents include polytetrafluoroethylene, vinylidene fluoride-hexafluoropropylene copolymer, styrene-butadiene copolymer rubber, polypropylene, polyethylene, polyacrylonitrile, acrylic resin, and the like.

As described later, the negative electrode layer 4 is produced by dispersing the aforementioned materials in a solvent to produce negative electrode ink, printing and applying the negative electrode ink, and heating and drying the negative electrode ink to remove the dispersion solvent. Conventional known dispersion solvents, such as NMP, water, and tetrahydrofuran, may be used as a dispersion solvent for the negative electrode ink.

The separator 3 according to the present invention is interposed between the positive electrode layer 2 and the negative electrode layer 4. The separator 3 includes an electrolyte so that the separator 3 serves to conduct only ions without conducting electrons. The separator 3 according to the present invention is not limited to a specific one. Any conventional known separator may be used. Examples of specific materials for the separator 3 include polyolefin, such as polypropylene or polyethylene, a porous film of fluororesin or the like, non-woven fabric, glass filter, and the like.

The electrolyte serves to transport charge carriers between the positive electrode layer 2 and the negative electrode layer 4. Generally, the electrolyte used has an ionic conductance of 10⁻⁵ S/cm to 10⁻¹ S/cm at a room temperature. For example, a mixed solvent of ethylene carbonate (EC) including 1.0 M of lithium phosphate hexafluoride (LiPF₆) as a supporting electrolyte and diethyl carbonate (DEC) (mixed volume ratio: EC/DEC=3/7) is used as the electrolyte. Nevertheless, conventional known electrolytes may be used. For example, a conventional known electrolyte in which an electrolyte salt is dissolved into a solvent may be used. Examples of such a solvent include organic solvents such as ethylene carbonate, propylene carbonate, dimethyl carbonate, diethyl carbonate, methyl ethyl carbonate, γ-butyrolactone, tetrahydrofuran, dioxolane, sulfolane, dimethylformamide, dimethylacetamide, and N-methyl-2-pyrrolidone, sulfuric acid solution, water, and the like. In the present invention, a single one of those solvents may be used, or two or more kinds of those solvents may be mixed and used. Furthermore, examples of the electrolyte salt include lithium salts such as LiPF₆, LiClO₄, LiBF₄, LiCF₃SO₃, LiN(CF₃SO₂)₂, LiN(C₂F₅SO₂)₂, LiC(CF₃SO₂)₃, and LiC(C₂F₅SO₂)₃. The concentration of the electrolyte salt is not specifically limited to 1.0 M.

The positive charge collector 1 is formed of a material including aluminum as a primary component, e.g., aluminum foil. The thickness of the positive charge collector 1 is about 40 μm, for example, and is not limited to this value. In view of the gas permeability, the thickness of the positive charge collector 1 is preferably at least 12 μm, more preferably at least 30 μm. Furthermore, in view of the energy density, the thickness of the positive charge collector 1 is preferably 100 μm or less, and more preferably 68 μm or less.

The negative charge collector 5 is formed of a material including copper as a primary component, e.g., copper foil. The thickness of the negative charge collector 5 is about 18 μm, for example, and is not limited to this value. In view of the gas permeability, the thickness of the negative charge collector 5 is preferably at least 8 μm, more preferably at least 15 μm. Furthermore, in view of the energy density, the thickness of the negative charge collector 5 is preferably 50 μm or less, and more preferably 30 μm or less.

In this manner, the positive charge collector 1 is formed of a material including aluminum as a primary component, and the negative charge collector 5 is formed of a material including copper as a primary component. Thus, it is possible to prevent the negative charge collector 5 from being alloyed with lithium included in the electrolyte and also to prevent the durability of the nonaqueous secondary cell from being considerably lowered.

The sealing material is used to prevent water vapor of outdoor air from being brought into contact with power generation components of the thin nonaqueous secondary cell. The sealing material comprises a multilayered structure including at least the positive fusion layer 6, the gas barrier layer 7, and the negative fusion layer 8. The sealing material may comprise multilayered structure with four or more layers by inserting an adhesive layer between the layers or using a plurality of fusion layers or gas barrier layers 7. Each one of layers may be superposed separately. A sealing material comprising a multilayered structure may be prepared and interposed. In any case, the same effects are expected if the sealing material being used comprises a multilayered structure consequently including at least the positive fusion layer 6, the gas barrier layer 7, and the negative fusion layer 8. Nevertheless, in view of the workability, it is preferable to interpose a three-layer film of modified polyolefin/liquid crystal polyester/modified polyolefin or ionomer resin/liquid crystal polyester/ionomer resin between the positive charge collector 1 and the negative charge collector 5.

The gas barrier layer 7 serves to prevent a water vapor gas from permeating into the interior of the cell from the exterior and also to prevent short circuits from being produced between the positive charge collector 1 and the negative charge collector 5. The material of the gas barrier layer 7 is not limited to a specific one. Nevertheless, it is preferable to use a liquid crystal polyester resin because a liquid crystal polyester resin has excellent gas barrier properties and good insulation characteristics and also has flexibility and resistance to bending.

The liquid crystal polyester resin is a generic name of liquid crystal polymers (thermotropic liquid crystal polymers) such as thermotropic liquid crystal polyester synthesized primarily from monomers of aromatic dicarboxylic acid and aromatic diol or aromatic hydroxycarboxylic acid, and liquid crystal polyester amide (thermotropic liquid crystal polyester amide). Typical examples of the liquid crystal polyester resin include Type I (the following chemical formula (1)) synthesized from p-hydroxybenzoic acid (PHB), terephthalic acid, and 4,4′-biphenol, Type II (the following chemical formula (2)) synthesized from PHB and 2,6-hydroxynaphthoic acid, and Type III (the following chemical formula (3)) synthesized from PHB, terephthalic acid, and ethylene glycol. The liquid crystal polyester resin according to the present invention may be any type of Types I, II, and III. In view of the heat resistance, the size stability, the water vapor barrier properties, the liquid crystal polyester resin is preferably fully aromatic liquid crystal polyester (Type I and Type II) or fully aromatic liquid crystal polyester amide. The liquid crystal polyester resin according to the present invention includes polymer blend with other components in which a liquid crystal polyester resin is contained at a ratio of 60 wt % or higher, and mixed composition with inorganic filler or the like.

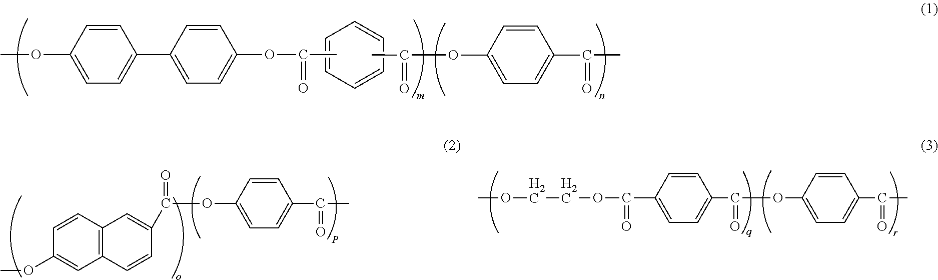

The form of the gas barrier layer 7 is not limited to a specific one. Nevertheless, the gas barrier layer 7 is preferably in the form of a film that can readily be processed. The term “film” in the present invention includes a sheet, a plate, foil (particularly with respect to a component material of a metal layer). In order to obtain such a base material, conventional known manufacturing methods may be used depending upon a resin of the base material. For example, a film using a liquid crystal polyester resin that is particularly suitable for the present invention is BIAC-CB (product name) made by Japan Gore-Tex Inc. The thickness of the gas barrier layer 7 according to the present invention is not limited to a specific value. However, if the gas barrier layer 7 is excessively thin, problems arise in insulation characteristics. If the gas barrier layer 7 is excessively thick, problems arise in gas barrier properties. Therefore, the thickness of the gas barrier layer 7 is between 1 μm and 700 μm, preferably between 5 μm and 200 μm, more preferably between 10 μm and 100 μm, and more preferably between 10 μm and 60 μm.

The positive fusion layer 6 and the negative fusion layer 8 serve to fuse the gas barrier layer 7 with the positive charge collector 1 and with the negative charge collector 5, respectively. The materials of the positive fusion layer 6 and the negative fusion layer 8 are not limited to specific ones. Examples of the materials of the positive fusion layer 6 and the negative fusion layer 8 include a modified polyolefin resin, an ionomer resin, and the like. The modified polyolefin resin according to the present invention refers to a resin in which, for example, polyethylene or polypropylene is graft-modified or copolymerized with a polar group of maleic anhydride, acrylic acid, or glycidyl methacrylate. The ionomer resin according to the present invention refers to a resin comprising a special structure in which, for example, molecules of ethylene-methacrylic acid copolymer or ethylene-acrylic acid copolymer are coupled with metal ions such as sodium or zinc by intermolecular bond. For the positive fusion layer 6 and the negative fusion layer 8 according to the present invention, a single one of those resins may be used, or several kinds of those resins may be mixed and used. The resins used for the positive fusion layer 6 and the negative fusion layer 8 have less gas barrier properties but better heat sealing properties as compared to the resin used for the gas barrier layer 7. Therefore, both excellent gas barrier properties and excellent heat sealing properties can be achieved by using the resins for the positive fusion layer 6 and the negative fusion layer 8 concurrently with the resin for the gas barrier layer 7.

The insulation layer 9 serves to prevent short circuits from being produced during operation. For example, a liquid crystal polyester resin is provided as the insulation layer 9.

When a material having a melting point that is at least 100° C. lower than the melting point of the gas barrier layer as a core is used as thermoplastic materials of the aforementioned positive fusion layer 6 and negative fusion layer 8, then the quality of products upon heat sealing can be stabilized.

[Manufacturing Method]

Next, an example of a manufacturing method according to a first embodiment will be described below with reference to FIG. 1.

<Production of Positive Electrode Layer>

A positive electrode layer 2 containing 90 wt % of lithium manganate comprising a Spinel structure, 5 wt % of graphite powder having an average grain diameter of 6 μm, 2 wt % of acetylene black, and 3 wt % of polyvinylidene fluoride (hereinafter PVDF) was produced on aluminum foil having a thickness of 40 μm. Liquid crystal polyester having 50 μm was attached to a rear face of the aluminum foil.

<Production of Negative Electrode Layer>

A negative electrode layer 4 containing 88 wt % of mesocarbon microbeads (hereinafter MCMB) graphitized at 2,800° C., which had been made by Osaka Gas Co., Ltd., 2 wt % of acetylene black, and 10 wt % of PVDF was produced on copper foil having a thickness of 18 μm. Liquid crystal polyester having 50 μm was attached to a rear face of the copper foil.

<Production of Secondary Cell>

The positive electrode layer 2 and the negative electrode layer 4 produced in the aforementioned manner were opposed to each other with interposing a separator 3 including an electrolyte between those electrodes and interposing a frame-shaped film of a sealing material comprising three layers of a modified polyolefin resin, a liquid crystal polyester resin, and a modified polyolefin resin between peripheries of the electrode layers. Thus, a thin secondary cell was obtained. A mixed solvent of ethylene carbonate (hereinafter EC) containing 1.0 M of LiPF₆ as a supporting electrolyte and diethyl carbonate (hereinafter DEC) (mixed volume ratio: EC/DEC=3/7) was used as the electrolyte.

### EXAMPLES

Next, the present invention will be described in greater detail along with specific examples.

### Example 1

Lithium manganate comprising a Spinel structure was measured to 90 wt %, and graphite powder having an average grain diameter of 6 μm as a conductivity provision agent was measured to 5 wt %. Acetylene black was measured to 2 wt %, and PVDF as binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 40 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode having a thickness of 140 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode having a thickness of 100 μm including the liquid crystal polyester and the copper foil was produced.

The positive electrode and the negative electrode produced in the above manner were opposed to each other with interposing a porous film separator therebetween. At that time, a frame-shaped film of a sealing material comprising three layers of maleic anhydride modified polypropylene, liquid crystal polyester, and maleic anhydride modified polypropylene, each having a thickness of 50 μm, was interposed between peripheries of the electrode layers. Three sides of the resultant rectangular layered body were heated and fused at a heater temperature of 190° C. An electrolyte of 60 mL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

### Example 2

Cobalt aluminum replaced lithium nickelate (LiNi_{0.80}Co_{0.15}Al_{0.05}O₂) comprising a layered rock salt structure was measured to 90 wt %, and graphite powder as a conductivity provision agent was measured to 5 wt %. Acetylene black was measured to 2 wt %, and PVDF as a binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 40 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode having a thickness of 140 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode having a thickness of 120 μm including the liquid crystal polyester and the copper foil was produced.

The positive electrode and the negative electrode produced in the above manner were opposed to each other with interposing a porous film separator therebetween. At that time, a frame-shaped film of a sealing material comprising three layers of maleic anhydride modified polyethylene, liquid crystal polyester, and maleic anhydride modified polyethylene, each having a thickness of 75 μm, was interposed between peripheries of the electrode layers. Three sides of the resultant rectangular layered body were heated and fused at a heater temperature of 150° C. An electrolyte of 60 μL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

In other words, a secondary cell was produced as follows: Instead of a lithium manganate comprising a Spinel structure in Example 1, a cobalt aluminum replaced lithium nickelate comprising a layered rock salt structure was used as an active material included in the positive electrode layer 2. The thickness of the negative electrode was set to be 120 μm, rather than 100 μm. The thickness of each layer of the sealing material was set to be 75 μm, rather than 50 μm.

### Example 3

Organic radical polymer, poly(2,2,6,6-tetramethylpiperidinooxy-4-ylmethacrylate) was measured to 70%, and vapor deposition carbon fiber was measured to 14%. Acetylene black was measured to 7%, and carboxymethyl cellulose was measured to 8%. Teflon (registered trademark) was measured to 1%. Those components were dispersed and mixed in water to produce positive electrode ink. Liquid crystal polyester having a thickness of 50 μm was attached to a rear face of aluminum foil having a thickness of 40 μm. The positive electrode ink produced in the above manner was printed and applied onto the aluminum foil by a screen printing method. The dispersion solvent of water was removed by heating and drying. Then compression molding was conducted with a roller press. Thus, a positive electrode having a thickness of 170 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode having a thickness of 100 μm including the liquid crystal polyester and the copper foil was produced.

The positive electrode and the negative electrode produced in the above manner were opposed to each other with interposing a porous film separator therebetween. At that time, a frame-shaped film of a sealing material comprising three layers of glycidyl methacrylate modified polyethylene, liquid crystal polyester, and glycidyl methacrylate modified polyethylene, each having a thickness of 100 μm, was interposed between peripheries of the electrode layers. Three sides of the resultant rectangular layered body were heated and fused at a heater temperature of 150° C. An electrolyte of 60 μL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

In other words, a secondary cell was produced as follows: Instead of a lithium manganate comprising a Spinel structure in Example 1, organic radical polymer, poly(2,2,6,6-tetramethylpiperidinooxy-4-ylmethacrylate) was used as an active material included in the positive electrode layer 2, and that the thickness of each layer of the sealing material was set to be 100 μm, rather than 50 μm.

### Comparative Example 1

A lithium manganate comprising a Spinel structure was measured to 90 wt %, and graphite powder having an average grain diameter of 6 μm an as a conductivity provision agent was measured to 5 wt %. Acetylene black was measured to 2 wt %, and PVDF as a binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 40 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode having a thickness of 140 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode having a thickness of 100 μm including the liquid crystal polyester and the copper foil was produced.

The positive electrode and the negative electrode produced in the above manner were opposed to each other with interposing a porous film separator therebetween. At that time, a frame-shaped film of a sealing material with maleic anhydride modified polyethylene having a thickness of 50 μm was interposed between peripheries of the electrode layers. Three sides of the resultant rectangular layered body were heated and fused at a heater temperature of 150° C. An electrolyte of 60 μL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

In other words, a secondary cell was produced so that the sealing material of Example 1 was formed by only one layer of maleic anhydride modified polyethylene.

### Comparative Example 2

A lithium manganate comprising a Spinel structure was measured to 90 wt %, and graphite powder having an average grain diameter of 6 μm as a conductivity provision agent was measured to 5 wt %. Acetylene black was measured to 2 wt %, and PVDF as a binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 40 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode having a thickness of 140 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode having a thickness of 100 μm including the liquid crystal polyester and the copper foil was produced.

The positive electrode and the negative electrode produced in the above manner were opposed to each other with interposing a porous film separator therebetween. At that time, a frame-shaped film of a sealing material with liquid crystal polyester having a thickness of 50 μm was interposed between peripheries of the electrode layers. An attempt was made to heat and fuse three sides of the resultant rectangular layered body at a heater temperature of 190° C. However, those sides could not satisfactorily be fused because the melting point of the liquid crystal polyester is excessively high.

In other words, an attempt was made to produce a secondary cell in which the sealing material of Example 1 was formed by only one layer of liquid crystal polyester. However, such a secondary cell could not be produced.

### Reference Example 1

A lithium manganate comprising a Spinel structure was measured to 90 wt %, and graphite powder having an average grain diameter 6 μm as a conductivity provision agent was measured to 5 wt %. Acetylene black was measured to 2 wt %, and PVDF as a binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 10 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode layer 2 having a thickness of 140 μm including the liquid crystal polyester and the aluminum foil was produced.

For a negative active material, MCMB graphitized at 2,800° C., which had been made by Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode layer 4 having a thickness of 100 μm including the liquid crystal polyester and the copper foil was produced.

The positive electrode layer 2 and the negative electrode layer 4 produced in the above manner were opposed to each other with interposing a porous film separator therebetween. At that time, a frame-shaped film of a sealing material comprising three layers of glycidyl methacrylate modified polyethylene, liquid crystal polyester, and glycidyl methacrylate modified polyethylene, each having a thickness of 50 μm, was interposed between peripheries of the electrode layers. Three sides of the resultant rectangular layered body were heated and fused at a heater temperature of 150° C. An electrolyte of 60 μL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

In other words, a secondary cell was produced so that the thickness of the aluminum foil in Example 1 was set to be 10 μm, rather than 40 μm.

### Reference Example 2

A lithium manganate comprising a Spinel structure was measured to 90 wt %, and graphite powder having an average grain diameter 6 μm as a conductivity provision agent was measured to 5 wt %. Acetylene black was measured to 2 wt %, and PVDF as a binding agent was measured to 3 wt %. Those components were dispersed and mixed in N-methylpyrrolidone (hereinafter NMP) to produce positive electrode ink. Liquid crystal polyester having a thickness of 50 μm was attached to a rear face of aluminum foil having a thickness of 70 μm. The positive electrode ink produced in the above manner was printed and applied onto the aluminum foil by a screen printing method. The dispersion solvent of NMP was removed by heating and drying. Then compression molding was conducted with a roller press. Thus, a positive electrode having a thickness of 140 μm including the liquid crystal polyester and the aluminum foil was produced.

For a negative active material, MCMB graphitized at 2,800° C., which had been made by

Osaka Gas Co., Ltd., was used. MCMB was measured to 88 wt %, and acetylene black as a conductivity provision agent was measured to 2 wt %. PVDF as a binding agent was measured to 10 wt %. Those components were dispersed and mixed in NMP to produce negative electrode ink. Liquid crystal polyester having a thickness of 50 μm was attached to a rear face of copper foil having a thickness of 18 μm. The negative electrode ink produced in the above manner was printed and applied onto the copper foil by a screen printing method. The dispersion solvent of NMP was removed by heating and drying. Then compression molding was conducted with a roller press. Thus, a negative electrode layer 4 having a thickness of 100 μm including the liquid crystal polyester and the copper foil was produced.

The positive electrode layer 2 and the negative electrode layer 4 produced in the above manner were opposed to each other with interposing a porous film separator therebetween. At that time, a frame-shaped film of a sealing material comprising three layers of maleic anhydride modified polypropylene, liquid crystal polyester, and maleic anhydride modified polypropylene, each having a thickness of 100 μm, was interposed between peripheries of the electrode layers. Three sides of the resultant rectangular layered body were heated and fused at a heater temperature of 190° C. An electrolyte of 60 μL was injected from the residuary opened side. A mixed solvent of EC containing 1.0 M of LiPF₆ as a supporting electrolyte and DEC (mixed volume ratio: EC/DEC=3/7) was used as the electrolyte. The entire cell was decompressed so that the electrolyte is well impregnated into voids. Then the residuary side was heated and fused under a reduced pressure. Thus, a thin secondary cell was obtained.

In other words, a secondary cell was produced as follows: The thickness of the aluminum foil in Example 1 was set to be 70 μm, rather than 40 μm. The thickness of each layer of the sealing material was set to be 100 μm, rather than 50 μm.

<Evaluation of Cells>

The method of Comparative Example 2 could not produce a cell as described above. Therefore, the cells produced by Examples 1 to 3, Comparative Example 1, and Reference Examples 1 and 2 were placed into a thermostatic bath at 20° C. Initial charging and discharging was conducted at a rate of 0.1 C. As a result, the cell produced by Comparative Example 1 could not obtain any capacity, and it was found that a short circuit was produced between the positive electrode and the negative electrode. Then, for the cells produced by Examples 1 to 3 and Reference Examples 1 and 2, charging and discharging was repeated at a rate of 1 C. The capacity of the cell of Reference Example 1 was lowered to not more than a half by five charging/discharging cycles. With the cell of Reference Example 2, it was found that no cells had any short circuit while the computed energy density was lowered.

Table 1 summarizes the stability, the number of short circuits, and the calculated energy density of the respective cells. As to the calculated energy density in Table 1, the calculated energy density of Example 1 is assumed to be 1.0. If the calculated energy density is equal to or higher than 1.0, it is represented by “o.” If the calculated energy density is between 0.2 and 0.3, it is represented by “Δ.” If the calculated energy density is equal to or lower than 0.2, it is represented by “x.”

TABLE 1

| | | Number of | Calculated |
|---|---|---|---|
| Specific Example | Stability | Short Circuits | Energy Density |
| Example 1 | ∘ | 0/5 | ∘ |
| Example 2 | ∘ | 0/3 | ∘ |
| Example 3 | ∘ | 0/3 | ∘ |
| Comparative Example 1 | — | 2/2 | ∘ |
| Comparative Example 2 | x | — | ∘ |
| Reference Example 1 | Δ | 0/2 | ∘ |
| Reference Example 2 | ∘ | 0/2 | Δ |

In the aforementioned examples, aluminum foil was used for the positive charge collector, and copper foil was used for the negative charge collector. Nevertheless, each of the positive charge collector and the negative charge collector may be formed of a metal material containing aluminum as a primary component and a metal material containing copper as a primary component, respectively.

A nonaqueous electrolyte secondary cell according to the present invention can demonstrate high adhesiveness with both electrode charge collectors, high reliability for prevention of short circuits, and satisfactory gas barrier properties while it is a thin cell using no outer covering members of aluminum film laminates. Therefore, a nonaqueous electrolyte secondary cell according to the present invention can widely be used with ease. Examples of applications of the present invention include IC cards, RFID tags, various types of sensors, portable electronic devices, and the like.

The present application is based upon and claims the benefit of priority from Japanese patent application No. 2010-197284, filed on Sep. 3, 2010, the disclosure of which is incorporated herein in its entirety by reference.

1. A nonaqueous secondary cell comprising:
a positive charge collector containing aluminum as a primary component;
a positive electrode layer formed on the positive charge collector;
a negative charge collector containing copper as a primary component;
a negative electrode layer formed on the negative charge collector so that the negative electrode layer is opposed to the positive electrode layer; and
a separator provided between the positive electrode layer and the negative electrode layer, the separator including an electrolyte,
wherein an inner surface of a periphery of the positive charge collector and an inner surface of a periphery of the negative charge collector are connected to each other while a sealing material comprising a multilayered structure including at least a positive fusion layer, a gas barrier layer, and a negative fusion layer is interposed between the inner surfaces of the peripheries of the positive charge collector and the negative charge collector.

2. The nonaqueous secondary cell as recited in claim 1, wherein the gas barrier layer contains a liquid crystal polyester resin as a primary component.

3. The nonaqueous secondary cell as recited in claim 1, wherein the positive fusion layer and the negative fusion layer contain, as a primary component, at least one of resins selected from the group consisting of a modified polypropylene resin, a modified polyethylene resin, and an ionomer resin.

4. The nonaqueous secondary cell as recited in claim 1, wherein the positive charge collector includes aluminum foil, and
the negative charge collector includes copper foil.

5. The nonaqueous secondary cell as recited in claim 1, wherein the positive charge collector has a thickness ranging from 12 μm to 68 μm.

6. The nonaqueous secondary cell as recited in claim 1, wherein the positive electrode layer includes nitroxyl radical polymer.

7. A method of manufacturing a nonaqueous secondary cell, comprising;
forming a film-like sealing material comprising a multilayered structure including at least a positive fusion layer, a gas barrier layer, and a negative fusion layer into a framed shape in which a central portion thereof has been punched out, interposing the film-like sealing material between a positive charge collector containing aluminum as a primary component and a negative charge collector containing copper as a primary component, and then connecting the positive charge collector and the negative charge collector to each other by heat sealing.

8. The method of manufacturing a nonaqueous secondary cell as recited in claim 7, wherein the gas barrier layer contains a liquid crystal polyester resin as a primary component, and
the positive fusion layer and the negative fusion layer contain, as a primary component, at least one of resins selected from the group consisting of a modified polypropylene resin, a modified polyethylene resin, and an ionomer resin.

9. The method of manufacturing a nonaqueous secondary cell as recited in claim 7, wherein the positive charge collector includes aluminum foil, and
the negative charge collector includes copper foil.

10. The method of manufacturing a nonaqueous secondary cell as recited in claim 7, wherein the positive charge collector has a thickness ranging from 12 μm to 68 μm.

11. The nonaqueous secondary cell as recited in claim 2, wherein the positive fusion layer and the negative fusion layer contain, as a primary component, at least one of resins selected from the group consisting of a modified polypropylene resin, a modified polyethylene resin, and an ionomer resin.

12. The nonaqueous secondary cell as recited in claim 2, wherein the positive charge collector includes aluminum foil, and
the negative charge collector includes copper foil.

13. The nonaqueous secondary cell as recited in claim 3, wherein the positive charge collector includes aluminum foil, and
the negative charge collector includes copper foil.

14. The nonaqueous secondary cell as recited in claim 2, wherein the positive charge collector has a thickness ranging from 12 μm to 68 μm.

15. The nonaqueous secondary cell as recited in claim 3, wherein the positive charge collector has a thickness ranging from 12 μm to 68 μm.

16. The nonaqueous secondary cell as recited in claim 4, wherein the positive charge collector has a thickness ranging from 12 μm to 68 μm.

17. The nonaqueous secondary cell as recited in claim 2, wherein the positive electrode layer includes nitroxyl radical polymer.

18. The nonaqueous secondary cell as recited in claim 3, wherein the positive electrode layer includes nitroxyl radical polymer.

19. The nonaqueous secondary cell as recited in claim 4, wherein the positive electrode layer includes nitroxyl radical polymer.

20. The nonaqueous secondary cell as recited in claim 5, wherein the positive electrode layer includes nitroxyl radical polymer.
